(19) United States
(12) Patent Application Publication
(10) Pub. No.: US 2013/0288641 A1
(43) Pub. Date: Oct. 31, 2013

(54) WIRELESS COMMUNICATION SYSTEM PROVIDING THE VERIFICATION OF THE NETWORK IDENTIFY

(71) Applicant: Dean Parsons, Easingwold North Yorkshire (GB)

(72) Inventor: Dean Parsons, Easingwold North Yorkshire (GB)

(73) Assignee: SIRRAN TECHNOLOGY LIMITED, Dublin (IE)

(21) Appl. No.: 13/824,670

(22) PCT Filed: Sep. 16, 2011
(86) PCT No.: PCT/EP11/66093

§ 371 Date: Jul. 3, 2013

(30) Foreign Application Priority Data
Sep. 16, 2010 (GB) 1015540.6

(51) Int. Cl. H04W 12/08

(52) U.S. Cl. CPC H04W 12/08
USPC 455/410

(57) ABSTRACT

There is discussed a wireless communication system in which a mobile communication device communicates with a telephone network using wireless signals, the telephone network operating in accordance with a telecommunications standard which does not provide for the verification of the identity of the network. The telephone network includes a database storing identification information for a plurality of trusted cell sites. The mobile communication device is operable to retrieve identification data for a cell and send the retrieved identification data to a network entity in the telephone network using a data transfer functionality provided by the telephone network, and in response to receiving the retrieved identification data the network entity is operable to verify the identification data using the database of stored identification information. Preferably, the data transfer functionality is the USSI) protocol.

The present invention relates to a wireless communication system in which a mobile communication device communicates with a telecommunications network via a wireless link. The invention has particular, but not exclusive, application when the telecommunications network operates in accordance with the Global System for Mobile communications (GSM) standard.

Wireless communication systems generally conform to a telecommunications standard, which specify many functional details of how equipment which conforms with that standard must operate. The GSM standard is a well-established standard which, although now being superseded by more advanced standards, is still in operation throughout the world. Indeed, although the Public Land Mobile Networks (PLMNs) in many countries are shifting from GSM technology to “third generation” (3G) technology, for some applications requiring a predictable cell structure GSM is still the preferred mobile communications standard.

Examples of such applications include military communication systems and emergency communication systems which can be set up at short notice following a disaster which may have disabled existing communication systems.

The GSM standard specifies a procedure by which the telecommunications network is able to verify the identity of a mobile communications device, and also provides for encrypted transmission of data between a mobile communications device and the telecommunications network. The GSM standard does not, however, provide any mechanism by which the mobile communications device can verify the identity of a telecommunications network, and in particular verify that the base station with which a wireless link is established is a genuine base station. This leaves open the possibility of a third party setting up a false base station to intercept data transmitted over the wireless link, and possibly then to forward the data to genuine components of a telecommunications network to avoid detection.

The inability of the mobile communications device to verify the identity of the telecommunications network has been addressed in 3G wireless communication standards. The present invention addresses the problem of how to verify the identity of the telecommunications network using equipment which operates in accordance with a telecommunications standard, such as the GSM standard, which does not itself provide for verification of the identity of the telecommunications network.

Aspects of the invention are set out in the accompanying claims.

According to an aspect of the invention, there is provided a wireless communication system in which a mobile communication device communicates with a telephone network using wireless signals, the telephone network operating in accordance with a telecommunications standard which does not provide for the verification of the identity of the network. The telephone network includes a database storing identification information for a plurality of trusted cell sites. The mobile communication device is operable to retrieve identification data for a cell and send the retrieved identification data to a network entity in the telephone network using a data transfer functionality provided by the telephone network, and in response to receiving the retrieved identification data the network entity is operable to verify the identification data using the database of stored identification information.

According to another aspect of the invention, there is provided a telephone network which operates in accordance with a telecommunications standard which does not provide for the verification of the identity of the network, the telephone network including a database storing identification information for a plurality of trusted cell sites and a network entity which, in response to receiving the identification data for a cell from a mobile communications device via a data transfer functionality, is operable to verify the identification data using the database of stored identification information.

According to a further aspect of the invention, there is provided a mobile communication device which is operable to retrieve identification information for a cell and send the received identification information to a network entity in the telephone network using a data transfer functionality.

For a mobile communication device operating in accordance with the GSM standard, the data communication functionality is preferably in accordance with the Unstructured Supplementary Service Data (USSD) protocol. Alternative possible data transfer functionalities include the Short Message Service (SMS) protocol.

Preferably, the signals transmitted between the mobile communication device and the telephone network are encrypted. To facilitate such encrypted communication, the telephone network includes a database storing cryptographic key information for a plurality of mobile communication devices.

An exemplary embodiment of the invention will now be described with reference to the attached figures in which:

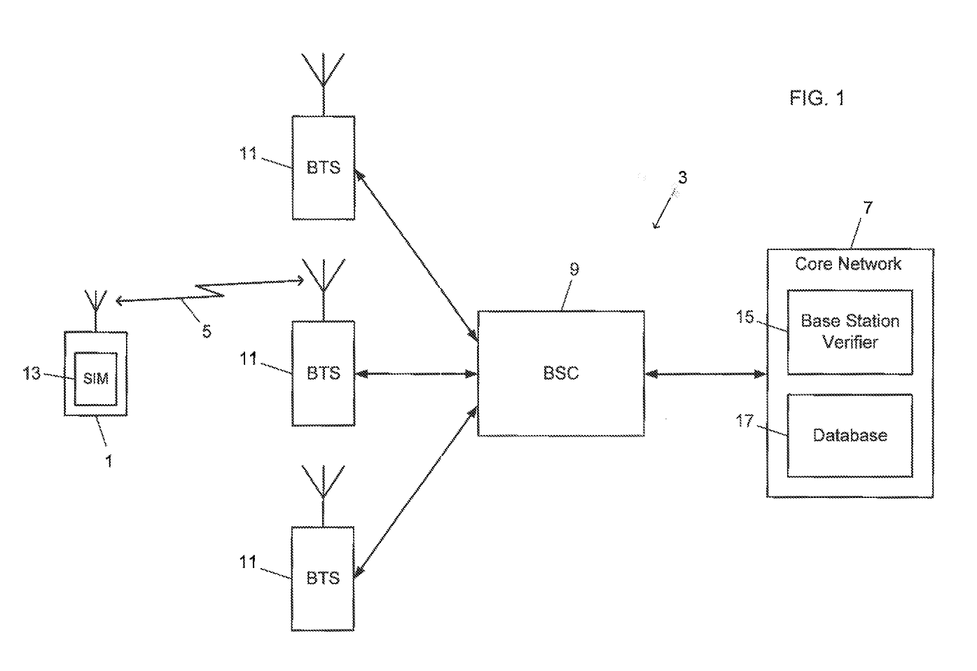

FIG. 1 is a block diagram schematically showing the main components of a wireless communication system according to the present invention; and

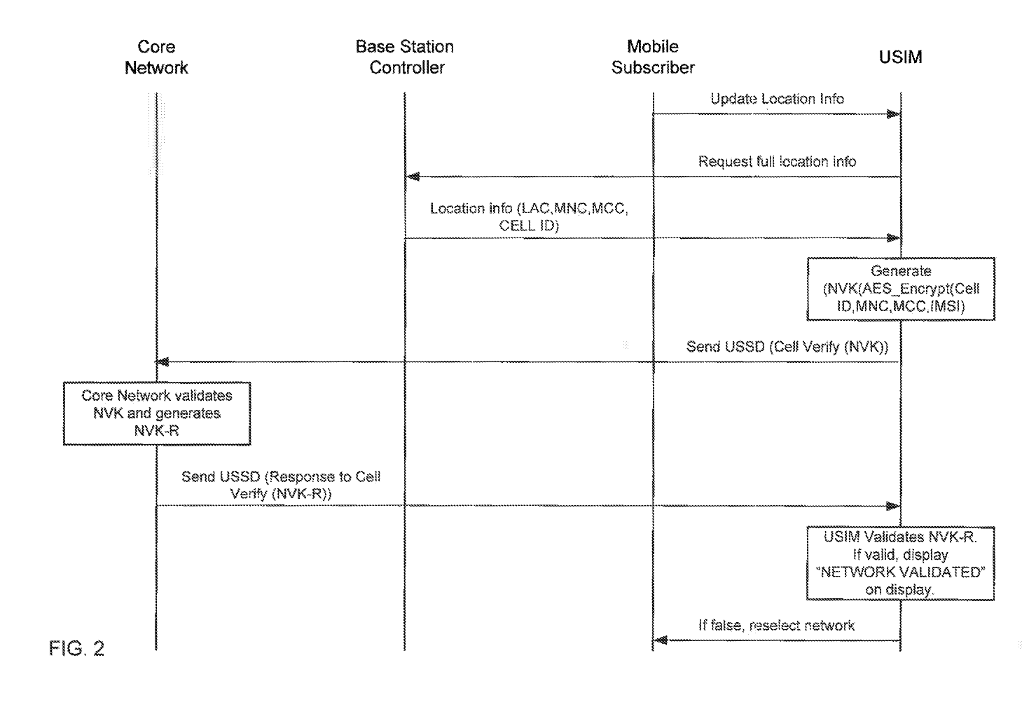

FIG. 2 is a signalling diagram showing signalling operations between the components of the wireless communication system illustrated in FIG. 1.

As shown in FIG. 1, in an embodiment of the present invention a mobile communication device 1 communicates with a mobile communications network 3 via a wireless link 5. In particular, in this embodiment the wireless link 5 is at radio frequencies and the mobile communications network 3 operates in accordance with the GSM standard.

The mobile communications network 3 includes a core network 7 which is connected to a plurality of base station controllers (BSCs) 9, only one of which is shown in FIG. 1 for ease of illustration. Each BSC 9 is connected to one or more base transceiver stations (BTSs) 11, three of which are shown in FIG. 1 for illustration. Each BTS 11 corresponds to a different cell of the mobile communications system, and the radio link 5 is set up between the mobile communication device 1 and one of the BTSs 11 (usually the nearest). As is well known, as the mobile communications device 1 moves, the radio link 5 may be handed over from one cell to another.

In this embodiment, the mobile communications device 1 includes a UICC card hosting a USIM (Universal Subscriber Identity Module) application 13. The USIM includes a novel applet which is used to verify that the BTS 11 with which a radio link is established is part of the communications network 3 with the assistance of a base station verifier 15 which forms part of the core network 7. The core network 7 also includes a database 17 which stores cell information associated with every BTS 11 of the mobile communications network 3. In this embodiment, the UICC card also stores a cryptographic key which is specific to the validation applet, a copy of which is also stored by the database 17 in association with the IMSI for the UICC card in a list storing cryptographic keys for a plurality of mobile communications devices authorised to use the mobile communications network 3.

The process by which a cell is validated will now be described with reference to FIG. 2. As shown, the process starts when the mobile subscriber (in effect, the part of the mobile communications device which is not the UICC card) informs the USIM 13 of new location info broadcast by a BTS. In particular, the mobile subscriber identifies a LOCATION-UPDATE message sent on a Broadcast Control Channel (BCCH) by a new BTS, and advises the USIM accordingly. The applet in the USIM then initiates the transmission of a message from the mobile communications device to the BSC for the new BTS requesting full location information, in response to which the BSC for the new BTS sends a message providing the Location Area Code (LAC), Mobile Network Code (MNC), Mobile Country Code (MCC) and Cell ID for the new BTS.

Following receipt of the full location information, the applet within the USIM generates a Network Validation Key (NVK) by concatenating the Cell_ID, MNC, MCC with the IMSI of the UICC card and then encrypting the resultant number using the cryptographic key stored by the UICC card using the 256-bit Advanced Encryption Standard (AES) cryptographic algorithm. The applet then initiates the sending of a USSD message indicating that a cell validation is requested and conveying the NVK to the base station verifier 15. USSD is a session-based data transfer protocol which allows real-time data transfer between the mobile communications device and the core network. Previously, USSD has been used, for example, to check for the amount of pre-paid credit outstanding for a “pay as you go” mobile telephone.

On receipt of the message requesting the cell validation, the base station verifier 15 looks up the cryptographic key for the mobile communications device 1, decrypts the NVK to retrieve the Cell_ID, MNC, MCC and the IMSI, and then verifies that the MNC and the MCC match those for the mobile communications network 3 and that the Cell_ID matches that of a valid Cell_ID as listed in the database 17. The base station verifier 15 then generates data indicating whether the new BTS is valid, and encrypts the data using the cryptographic key associated with the mobile communications device 1 to generate a response NVK-R. The base station verifier 15 then sends a USSD message conveying the response NVK-R to the mobile communications device 1.

Following receipt of the USSD message conveying the NVK-R response, the USIM 13 in the mobile communications device 1 decrypts the response NVK-R to recover the data indicating whether or not the new BTS is valid. If the data indicates that the new BTS is valid, the USIM 13 initiates the display of a “Network Validated” message on the display of the mobile communications device. If the data indicates that the new BTS is not valid, then the USIM 13 instructs the mobile subscriber to select a different BTS.

The cell validation process described above is fully compatible with the GSM standard. Accordingly, it is compatible with standard GSM network components. By incorporating the cell validation process into an applet in a USIM, the need for any client application in the mobile subscriber (i.e. the handset) is avoided. Further, the UICC card has security features which protect the security of the applet and its associated cryptographic key.

The list of trusted cells stored in the database 17 can be updated at any time. As soon as a new trusted cell is added, its identity can be validated. This is particularly advantageous in applications in which additional cells are being frequently added, for example the setting up of an emergency communication system after a disaster.

### Modifications and Further Embodiments

In the illustrated embodiment, the mobile communications network operates in accordance with the GSM standard. Preferably, the GSM network has EDGE (Enhanced Data for Global Evolution) functionality to allow for better data transfer rates. Such a GSM network is sometimes referred to as 2.75G, and is the specified network for some military applications. Alternatively, the GM network may utilise so-called 2G or 2.5G technology.

It will be appreciated that later telecommunications standards may include back-compatibility with earlier telecommunications standards so that, for example, a UMTS wireless network can operate with a GSM cellular telephone. In this regard, it is noted that although network equipment operating in accordance with the UMTS standard is compatible with the GSM standard, it is not correct to say that UMTS network equipment operates in accordance with the GSM standard. In other words, the wording “equipment which operates in accordance with a telecommunications standard which does not provide for verification of the identity of the telecommunications network” does not encompass equipment which is compatible with such equipment but operates in accordance with a standard which does provide for verification of the identity of the telecommunications network.

As discussed in the illustrated embodiment, the base station verifier forms part of the core network. In practice, the base station verifier is a network entity which is in connection with the core network. It need not be in the vicinity of the BTSs, and may well be in a completely different country to the BTSs. The database storing the details of valid cells may be hosted by the same network device as the base station verifier, or alternatively may be hosted by a different network device to the base station verifier. Similarly, the database storing the cryptographic keys for different mobile communications devices may be hosted by the same network device as the base station verifier, or alternatively may be hosted by a different network device to the base station verifier. The database storing the cryptographic keys for different network devices may or may not be stored in the same network device as the database storing the details of valid cells.

Although it is preferred that the base station verification functionality within the mobile communications device is implemented in an applet in a USIM, this is not essential. Such base station verification functionality could alternatively be implemented by software agents within any form of subscriber identity module, or even within the handset of the mobile communications device itself.

The use of USSD messages to communicate data between the USIM and the base station verifier is preferred as it involves no “store and forward” mechanism. However, data transfer mechanisms which do use a “store and forward” mechanism, such as the Short Message Service (SMS), could alternatively be used.

In the illustrated embodiment, the AES cryptographic algorithm is used to encrypt data communicated between the mobile communications device and the core network. The AES cryptographic algorithm is a symmetric algorithm, i.e. the same cryptographic key is used to encrypt and decrypt data. It will be appreciated that alternative symmetric cryptographic algorithms could be used. Further, an asymmetric cryptographic algorithm could be used in which different keys are used to encrypt and decrypt the data, which may involve the usage of a Public Key Infrastructure (PKI) as is well known in the art of cryptography.

The mobile communication device can be any mobile communication device operable to communicate with a cellular communications network. In addition to cellular phones (sometimes referred to as mobile phones or handy phones, the invention could also be applied in a personal digital assistant or a portable computer or the like

The embodiment described with reference to the drawings involves performing process instructions defined by a computer program using some form of processing apparatus. The invention therefore also extends to computer programs, particularly computer programs on or in a carrier, adapted for putting the invention into practice. The program may be in the form of source code, object code, a code intermediate to source code and object code such as in partially compiled form, or in any other form suitable for using in the implementation of the processes according to the invention.

The carrier may be any entity or device capable of carrying the program. For example, the carrier may comprise a storage medium, such as a ROM, for example a CD-ROM or a semiconductor ROM, or a magnetic recording medium, for example a floppy disc or a hard disc, or an optical recording medium. Further, the carrier may be a transmissible carrier such as an electronic or optical signal which may be conveyed via electrical or optical cable or by radio or other means.

The carrier may be an integrated circuit in which the program is embedded, the integrated circuit being adapted for performing, or for use in the performance of, the relevant processes. Although the invention may be implemented by software, it will be appreciated that alternatively the invention could be implemented by hardware devices or a combination of hardware devices and software.

1. A wireless communication system comprising a communications network and a mobile communications device operable to communicate with the communications network using wireless signals, wherein the communications network operates in accordance with a telecommunications standard which does not provide for the verification of the identity of the network,
the mobile communication device being operable to retrieve identification data for a cell and send the retrieved identification data to a network entity in the communications network using a data transfer functionality supported by the communications network, and
said network entity being operable, in response to receiving the retrieved identification data from the mobile communication device, to verify the identification data using a database of identification information for trusted cells, and to transmit a result of said verification to the mobile communication device.

2. A wireless communication system according to claim 1, wherein the communications network operates in accordance with the GSM standard.

3. A wireless communication system according to claim 2, wherein said data transfer functionality utilises the Unstructured Supplementary Service Data protocol.

4. A wireless communication system according to claim 2, wherein said data transfer functionality utilises the Short Message Service protocol,

5. A wireless communication system according to claim 1, wherein the mobile communication device is operable to encrypt the retrieved identification data prior to transmission to the network entity using a cryptographic algorithm and a cryptographic key stored by the mobile communication device,

6. A wireless communication device according to claim 5, wherein the cryptographic algorithm is a symmetric cryptographic; algorithm.

7. A network entity for a communications network which operates in accordance with a telecommunications standard which does not provide for the verification of the network, the network entity being operable, in response to receiving, data identifying a base station from the mobile communication device via a data transfer functionality supported by telecommunications standard, to verify the identification data using a database of authentic base stations, and to transmit a result of said verification to the mobile communication device.

8. A network entity according to claim 7, wherein the communications network operates in accordance with the GSM standard.

9. A network entity according to claim 8, wherein said data transfer functionality utilises the Unstructured Supplementary Service Data protocol.

10. A network entity according to claim 8, wherein said data transfer functionality utilises the Short Message Service protocol.

11. A network entity according to claim 7, wherein said received identification data is encrypted and the network entity is operable to decrypt the encrypted identification information using a cryptographic key stored in a database of cryptographic keys for mobile communication devices.

12. A network entity according to claim 11, wherein the cryptographic algorithm is a symmetric cryptographic algorithm.

13. (canceled)

14. (canceled)

15. (canceled)

16. (canceled)

17. (canceled)

18. (canceled)

19. (canceled)

20. A UICC card storing a computer program for programming a mobile communications device which is operable to communicate with a communications network using wireless signals, wherein the communications network operates in accordance with a standard which does not provide for the verification of the network, the computer program comprising instructions for implementation by the mobile communications device to retrieve identification data for a cell of the communications network and send the retrieved identification data to a network entity in the communications network using a data transfer functionality supported by the communications network.

21. (canceled)

22. A method of validating a base station of a wireless communications network which operates in accordance with a telecommunications standard which does not provide for the validation of the identity of the network, the method comprising:
a mobile communication device retrieving identification data for a cell and sending the retrieved identification data to a network entity in the communications network using a data transfer functionality supported by the communications network; and
said network entity, in response to receiving the retrieved identification data from the mobile communication device, verifying the identification data using a database of identification information for trusted cells, and transmitting a result of said verification to the mobile communication device.

23. A A method according to claim 22, wherein the communications network operates in accordance with the GSM standard.

24. A A method according to claim 23, wherein said data transfer functionality utilises the Unstructured Supplementary Service Data protocol.

25. A A method according to claim 24, wherein said data transfer functionality utilises the Short Message Service protocol.

26. A method according to claim 22, wherein the mobile communication device encrypts the retrieved identification data prior to transmission to the network entity using a cryptographic algorithm and a cryptographic key stored by the mobile communication device.

27. A A method according to claim 26, wherein the cryptographic algorithm is a symmetric cryptographic algorithm.
